(19) United States
(12) Patent Application Publication
(10) Pub. No.: US 2016/0228846 A1
(43) Pub. Date: Aug. 11, 2016

(54) THREE-DIMENSIONAL GRAPHENE OXIDE MICROSTRUCTURE AND METHOD FOR MAKING THE SAME

(71) Applicant: NATIONAL CHENG KUNG UNIVERSITY, Tainan City (TW)

(72) Inventors: SHEAN-JEN CHEN, TAINAN CITY (TW); CHUN-YU LIN, TAINAN CITY (TW); HSIN-YU CHANG, TAINAN CITY (TW); TE-FU YEH, TAINAN CITY (TW); HIS-SHENG TENG, TAINAN CITY (TW)

(21) Appl. No.: 14/614,522

(22) Filed: Feb. 5, 2015

(51) Int. Cl. B01J 19/12; C01B 31/04

(52) U.S. Cl. CPC B01J 19/128; C01B 31/043; B01J 19/122

(57) ABSTRACT

The present invention is related to a three-dimensional graphene oxide microstructure and making method of thereof. First, a photoreactive agent is added into a graphene oxide solution, wherein the photoreactive agent is a photoreactivator in a nonlinear optical method. Then, the photoreactivator in the graphene oxide solution is activated by a beam emitted from an excitation module to produce singlet oxygen with high activity. Finally, the graphene oxide is activated by the singlet oxygen for an unpaired electron of the graphene oxide covalently bonding with another graphene oxide to form a three-dimensional graphene oxide microstructure. Therefore, two-dimensional graphene oxides are efficiently cross-linked with each other to form a three-dimensional graphene oxide microstructure by a nonlinear optical technique of an ultrafast laser system so as to apply to the development of all electronic and optical components.

### BACKGROUND OF THE INVENTION

1. Field of the Invention

The present invention relates a three-dimensional graphene oxide microstructure and a method for making the same. More particularly, the method is a method for making all free form of the three-dimensional graphene oxide microstructure, in which method two-dimensional graphene oxides are efficiently cross-linked with each other to form a three-dimensional graphene oxide microstructure via a nonlinear optical technique of an ultrafast laser system so as to apply to the development of all electronic and optical components.

2. Description of Related Art

Graphene is a thin flat sheet with a hexagon and honeycomb crystal lattice made of carbon atom in a Sp² hybrid orbital and is a two-dimensional material with one carbon atom thick. Graphene is the thinnest but the hardest material of the world. Graphene has well optical, electrical, and mechanical properties, and also has well transparent properties, so it is applied to transparency conducting layer, transparent composites, or flexible electronics. Moreover, graphene is efficiently applied to capacitor, electrode of lithium battery, and composites for mechanical strengthening.

From now, the research and application of graphene is toward to the development of two-dimensional structure, for example, the development of transparent panel, ultrahigh speed transistor, graphene capacitor, and conductive ink. Every manufacturer in graphene industry hope to occupies a leading position of the application of two-dimensional structure. Graphene can be produced by several methods, for example, graphene can be produced from graphite by Hummer's method or improved Hummer's method, or can be produced in the form of a single graphite structure on the nickel surface by ethylene cleavage via chemical vapor deposition, or even can be mass produced by a method similar to a semiconductor process. However, no matter what method described above is used for making graphene, it is merely more and more in-depth research and application of two-dimensional structure. Because the inherent hexagonal carbon structure of the graphene could not efficiently form a three-dimensional structure, the more sophisticated and more difficult development of graphene is limited. Therefore, how to efficiently produce a three-dimensional graphene oxide net structure by cross-linking with each other to design and produc any size of the three-dimensional microstructure of the graphene oxide whereby producing any module structure to apply in any industry and to mix with any element is the main problem to be resolved by the researchers in the graphene development.

### SUMMARY OF THE INVENTION

According to the above description, the present graphene is mainly developed in a two-dimensional hexagonal carbon structure, and a three-dimensional graphene oxide structure cannot be produced because of defects in the present graphene.

Therefore, the object of the present invention is to provide a three-dimensional graphene oxide microstructure and a method for making the same. More particularly, the method is a method for making all free form of the three-dimensional graphene oxide microstructure, in which method two-dimensional graphene oxides are efficiently cross-linked with each other to form a three-dimensional graphene oxide microstructure by a nonlinear optical technique of an ultrafast laser system so as to apply to the development of all electronic and optical components.

For the above object, a method for making a three-dimensional graphene oxide microstructure comprises the steps below. First, a photoreactive agent is added into a graphene oxide solution, wherein the photoreactive agent is a photoreactivator in a nonlinear optical method. Then, the photoreactivator in the graphene oxide solution is activated by a beam emitted from an excitation module to produce singlet oxygen with high activity. Finally, the graphene oxide is activated by the singlet oxygen for an unpaired electron of the graphene oxide covalently bonding with another graphene oxide to form a three-dimensional graphene oxide microstructure.

According to an embodiment of the present invention, the photoreactive agent is a rose Bengal (RB).

According to an embodiment of the present invention, the graphene oxide solution is prepared by immersing graphene oxide quantum dots (GQD) into an aqueous solution, in order to provide a sufficient efficiency of two-photon cross-linking (TPC), the concentration of the graphene oxide quantum dots is 20 mg/ml, and the concentration of the rose Bengal is 5 mM.

According to an embodiment of the present invention, the graphene oxide quantum dots are prepared by aerating argon into graphene oxide nanosheets and removing a large size of graphene oxide quantum dots by centrifugation to obtain a graphene oxide quantum dots with the grain size from 2 nm to 5 nm.

According to an embodiment of the present invention, in centrifugation step, the method further comprises a wash step for washing the graphene oxide quantum dots by ethanol, and a drying step for drying the graphene oxide quantum dots in an oven at 60° C. for 48 hours.

According to an embodiment of the present invention, the graphene oxide nanosheets are prepared by a preparation method, comprising the steps described below. First, a ground graphite powder is mixed with sodium nitrate (NaNO₃) and sulfuric acid (H₂SO₄) in an ice bath container to form a first mixture. Then, potassium permanganate (KMnO₄) is mixed into the first mixture by a stir to form a second mixture, wherein the temperature is kept below 20° C. Next, the temperature of the second mixture is elevated to 3020 C.˜40° C. and the second mixture is continuously stirred until the graphite is oxidized. After the graphite is oxidized, the second mixture is diluted with deionized water, and a hydrogen peroxide (H₂O₂) is added into the second mixture and the second mixture is continuously stirred after dilution. Finally, the second mixture is dried to obtain the graphene oxide nanosheets.

According to an embodiment of the present invention, the nonlinear optical method is a two-photon cross-linking (TPC) method or a two-photon polymerization (TPP) method, the photoreactive agent is a photoactivator in the two-photon cross-linking method and is a photoinitiator in the two-photon polymerization method.

According to an embodiment of the present invention, the excitation module is a femtosecond laser, the wavelength of the laser beam emitted from the femtosecond laser is from 700 nm to 800 nm, and the power of the laser beam is from 5 mW to 15 mW.

A three-dimensional graphene oxide microstructure made by the foregoing method is also provided.

Therefore, in the method for making the three-dimensional oxide microstructure in the present invention, a two-photon polymerization is carried on by multi-photon excitation of a nonlinear optical method in an ultrafast laser system to efficiently form all free form of the three-dimensional graphene oxide microstructure for development of the application in three-dimensional composites. In addition, in the method for making the three-dimensional graphene oxide microstructure in the present invention, the femtosecond laser instantly provides enough photon energy density in the focusing point to process the production of the three-dimensional microstructure of the graphere oxide, and the three-dimensional microstructure of the reduced graphene oxide (rGO) is efficiently produced via tuning the laser power and the scan rate of the femtosecond laser to achieve different levels of GO reduction and integrity of the structure. Moreover, utilization of two-photon processing technique in the method for making the three-dimensional graphene oxide microstructure in the present invention, any size of the three-dimensional microstructure of the graphene oxide can be efficiently designed and produced whereby producing any module structure to apply to any industry, and the three-dimensional microstructure of the graphene oxide can mix with any element to form a transistor containing p type and n type simultaneously and can efficiently integrate with biocompatible materials, proteins or organic framework to form a microfluidic biochip or precursor of disease, even to form optical material via three-dimensional mode for creating ultrashort pulse, whereby widely and efficiently applying to the development of photoelectric industry and biomedical industry. The method for making the three-dimensional graphene oxide microstructure in the present invention improves the difficulty in the development of transparent panel, ultrahigh speed transistor, graphene capacitor, and conductive ink. In the other words, the three-dimensional graphene oxide microstructure and the method for making the same in the present invention can efficiently improve the problem that hexagonal carbon structure of the traditional graphene can not be formed three-dimensional type and efficiently remedy the defects of the traditional graphene for making any free form of the three-dimensional graphene oxide microstructure. The three-dimensional graphene oxide microstructure and the method for making the same in the present invention utilizes the unique characteristics of the graphene like special bandgap, electric charge and ultrasmall resistance to make any photoelectric element such as optical amplifier, field-effect transistor, and wavelength shifter for expanding the development of three-dimensional composites and accelerating the development of high-speed transistor or super capacitor whereby reducing the size of the traditional electric elements and accelerating the development of superconductive industry.

### BRIEF DESCRIPTION OF THE DRAWINGS

FIG. 1 shows a flow chart of a method for making a three-dimensional graphene oxide microstructure according to an embodiment of the present invention;

FIG. 2 shows a reaction scheme for graphene oxides bonding with each other catalyzed by singlet oxygen in a method for making a three-dimensional graphene oxide microstructure according to the embodiment of the present invention;

FIG. 3 shows optical micrographs of three-dimensional graphene oxide microstructures being aerated nitrogen under different times according to the embodiment of the present invention;

FIG. 4 shows a transmission electron micrograph of a graphene oxide quantum dots in a method for making a three-dimensional graphene oxide microstructure according to the embodiment of the present invention;

FIG. 5 shows scanning images of a three-dimensional graphene oxide microstructure by a two-photon scanning microscope according to the embodiment of the present invention; and

FIG. 6 shows a perspective view of a three-dimensional graphene oxide microstructure according to the embodiment of the present invention.

### DETAILED DESCRIPTION OF THE PREFERRED EMBODIMENT

In order to understand the three-dimensional graphene oxide microstructure and the method for making the same in the present invention, the basic concept of the graphene is described below. Graphene is a thin flat sheet with a hexagon and honeycomb crystal lattice made of carbon atom in a Sp² hybrid orbital and is a two-dimensional material with one carbon atom thick. As a result, graphene can be described as a one-atom thick layer of graphite. Graphene is the thinnest but the hardest nanomaterial of the world and is nearly transparent. Graphene only absorbs 2.3% of white light; the thermal conductivity of graphene is up to 5300 W/mK and it is much higher than the value observed in carbon nanotube and diamond. At the room temperature, the electron mobility of the graphene is more than 15000 cm²/Vs and it is higher than the value observed in nanotubes (about 10000 cm²/Vs) and monocrystalline silicon (about 1400 cm²/Vs). The resistivity of the graphene is only 10⁻⁶ Ω·cm, much lower than the resistivity of metals like cooper and silver, and the graphene is a nanomaterial with the smallest resistivity. Graphene has the properties of metal and semiconductor. Like the general common semiconductor material, graphene c an be doped by different gas to form n-type or p-type semiconductor, and if it is heated, the doped gas can be removed thereby returning to original graphene.

Because graphene has extremely low resistivity and extremely fast electron mobility, it is expected to replace crystalline silicon to sharply reduce the size of the chip, resulting in the development of new generation electric element or transistor with thinner thick and faster conductivity. Furthermore, graphene is a transparent and well conductor, and it is suitable to make transparent touch panel, flexible display, light plate, even solar cell.

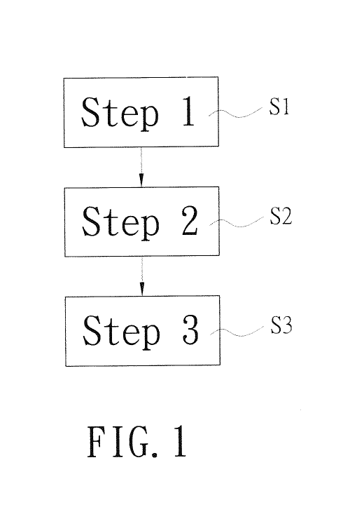

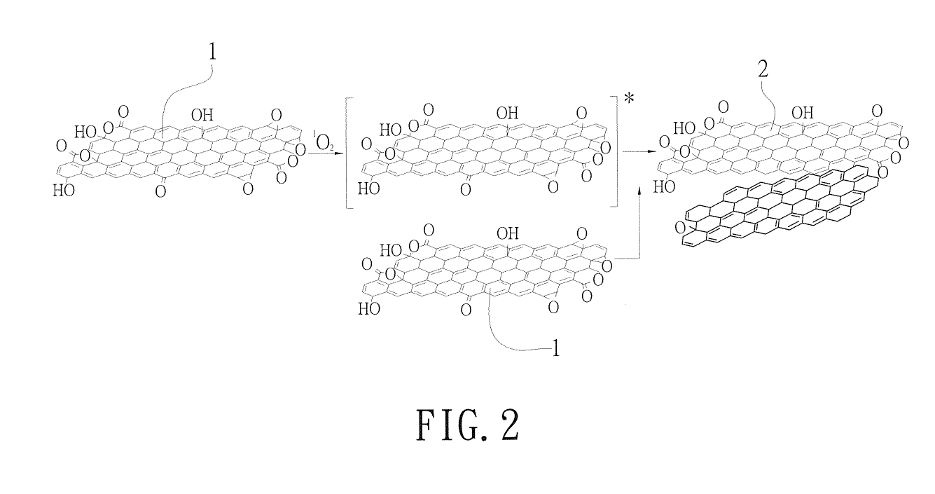

Please refer to FIG. 1 and FIG. 2, they show a flow chart of a method for making a three-dimensional graphene oxide microstructure and a reaction scheme for graphene oxides bonding with each other catalyzed by singlet oxygen in the method for making a three-dimensional graphene oxide microstructure according to the embodiment of the present invention. The method for making a three-dimensional graphene oxide microstructure comprises the steps described below.

In step 1 (S1), a photoreactive agent is added into a graphene oxide solution, wherein the photoreactive agent is a photoreactivator in a nonlinear optical method. In an embodiment, the photoreactive agent is a rose Bengal (RB). The nonlinear optical method is a two-photon cross-linking (TPC) method or a two-photon polymerization (TPP) method, the photoreactive agent is a photoactivator in the two-photon cross-linking method and is a photoinitiator in the two-photon polymerization method.

In step 2 (S2), the photoreactivator in the graphene oxide solution is activated by a beam emitted from an excitation module to produce a singlet oxygen with high activity. According to an embodiment, the excitation module is a femtosecond laser, the wavelength of the laser beam emitted from the femtosecond laser is from 700 nm to 800 nm, and the power of the laser beam is from 5 mW to 15 mW. According to another embodiment, the wavelength of the laser beam emitted from the femtosecond laser is 730 nm, and the power of the laser beam is 10 mW. When the laser beam emitted from the femtosecond laser of the excitation module reaches to the rose Bengal (RB) in the graphene oxide solution, the rose Bengal (RB) becomes free radical form (RB*) and than reacts with triplet oxygen (³O₂) in the graphene oxide solution to reduce the rose Bengal (RB) and produce singlet oxygen (¹O₂). The reaction is shown below.

$$RB {}^{visible light} {RB}^{*}$$

$${RB}^{*} + {}_{}^{3}{O}{}_{2}^{} \to RB + {}_{}^{1}{O}{}_{2}^{}$$

Utilization of the photon energy density in the focusing point instantly provided by the femtosecond laser, singlet oxygen (¹O₂) with high activity is efficiently produced in the graphene oxide solution after excitation.

In step 3 (S3), a graphene oxide 1 is activated by the singlet oxygen for an unpaired electron of the graphene oxide 1 covalently bonding with another graphene oxide 1 to form a three-dimensional graphene oxide microstructure 2. In an embodiment of the present invention, the singlet oxygen produced in step 2 (S2) activates the graphene oxide 1 become having an unpaired electron, and the graphene oxide 1 having the unpaired electron is covalently compounded with another graphene oxide 1 via two-photon cross-linking to form a three-dimensional graphene oxide microstructure 2.

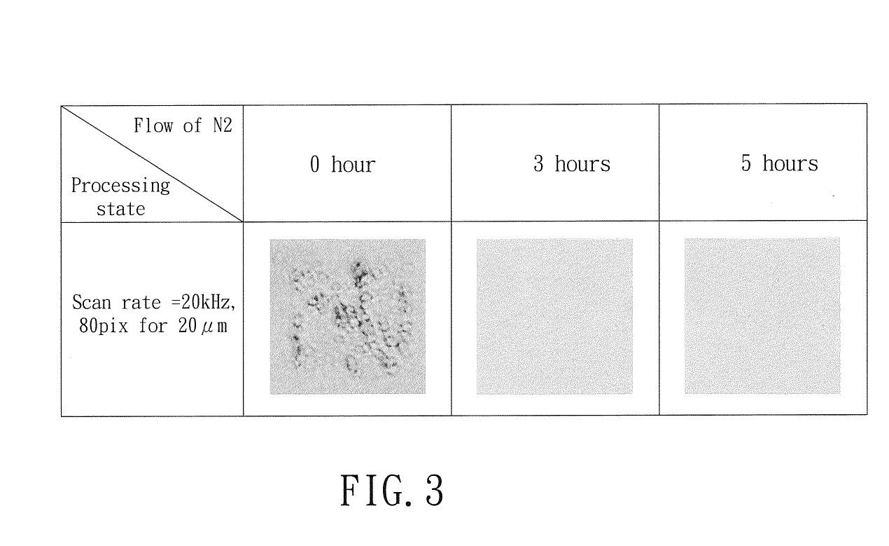

In addition, FIG. 3 shows optical micrographs of three-dimensional graphene oxide microstructures being aerated nitrogen, under different times according to the embodiment of the present invention. The importance of the singlet oxygen in the method for making a three-dimensional graphene oxide microstructure is verified by an inverted optical microscope (OM) with a 40× objective having a numerical aperture (NA) of 1.3. In an embodiment of the present invention, when nitrogen is not aerated (0 hr) in the method for making a three-dimensional graphene oxide microstructure, the three-dimensional graphene oxide microstructure 2 is obviously shown in the optical micrograph. However, when the aerated time of nitrogen is up from 3 hours to 5 hours in the method for making a three-dimensional graphene oxide microstructure, the triplet oxygen in the graphene oxide solution is decreased, and the activated singlet oxygen cannot be produced enough to process two-photon cross-linking for making a three-dimensional graphene oxide microstructure. It does not show any three-dimensional graphene oxide microstructure in the optical micrograph. It means that the aerated nitrogen makes the graphene oxide solution in an anoxic state, so the source of singlet oxygen cannot be provided to process that graphene oxide is compounded with each other. Therefore, the three-dimensional graphene oxide microstructure cannot be formed. The above experiment is used to verify the importance of the singlet oxygen.

The preparation of the foregoing graphene oxide solution is described below. First, 5 g of ground graphite powder is mixed with 2.5 g of sodium nitrate and 115 ml of 18M sulfuric acid in an ice bath container to form a first mixture. Then, 15 g of potassium permanganate is mixed into the first mixture by a stir to form a second mixture, wherein the temperature is kept below 20° C. The potassium permanganate is a strong oxidant to oxidize the graphite. Next, the temperature of the second mixture is elevated to 30° C.˜40° C. and the second mixture is stirred continuously until the graphite is oxidized. In an embodiment of the present invention, the second mixture is continuously stirred for 24 hours at 35° C. until the graphite is oxidized. After the graphite is oxidized, 230 ml of deionized water is added into the second mixture and the temperature of the second mixture is elevated to 95° C.˜100° C. In an embodiment of the present invention, the second mixture is stirred for 15 minutes at 98° C. Then, the second mixture is diluted to 700 ml and continuously stirred for 30 minutes. After dilution, 12 ml of 35 wt % hydrogen peroxide is added into the second mixture and continuously stirred. Then, the second mixture is washed with 500 ml deionized water for 3 times, and the final precipitate is dried at 40° C. or 24 hours to obtain graphene oxide nanosheets. However, the large size of graphene oxide nanosheet induces a serious of thermal damage to destroy the microstructure during the process. Therefore, in order to prevent the thermal damage, the size of the graphene oxide nanosheet must be small, and the efficiency of two-photon cross-linking is increased. That is the reason why the ground graphite powder is used for the preparation of the graphene oxide solution.

Next, argon is aerated into the graphene oxide nanosheet for 3 hours to obtain graphene oxide quantum dots, and a large size of the graphene oxide quantum dots is removed by centrifuge. After that, the graphene oxide quantum dots are repeatedly washed by ethanol and then centrifuged to collect pure graphene oxide quantum dots, and the graphene oxide quantum dots are dried by oven at 60° C. for 48 hours.

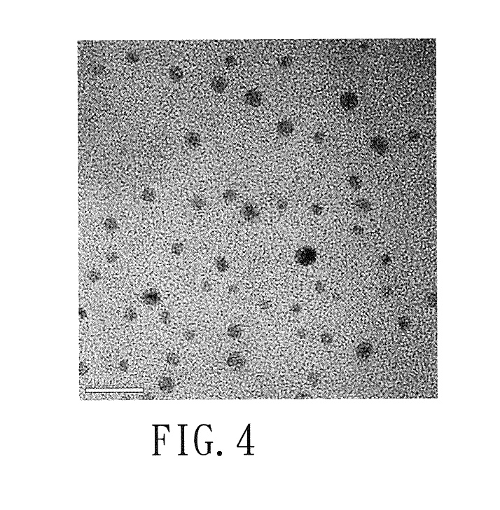

FIG. 4 shows a transmission electron micrograph of a graphene oxide quantum dots in a method for making a three-dimensional graphene oxide microstructure according to the embodiment of the present invention. According to the transmission electron micrograph (TEM), the grain size of the graphene oxide quantum dots is 2 nm to 5 nm. Finally, the graphene oxide quantum dots are immersed into an aqueous solution to prepare a graphene oxide solution. In an embodiment of the present invention, the concentration of the graphene oxide quantum dots and the rose Bengal are 20 mg/ml and 5 mM respectively to provide a sufficient efficiency of two-photon cross-linking.

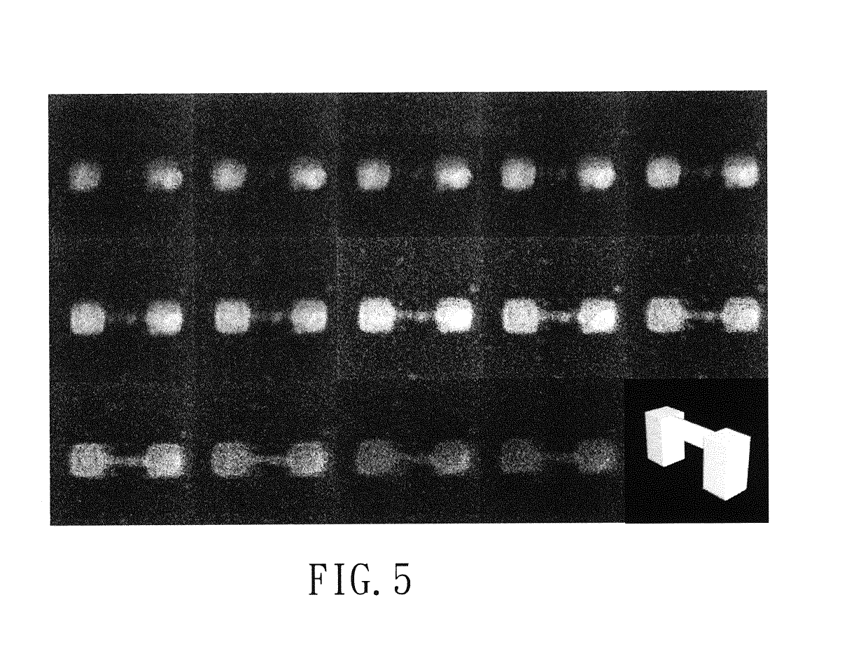

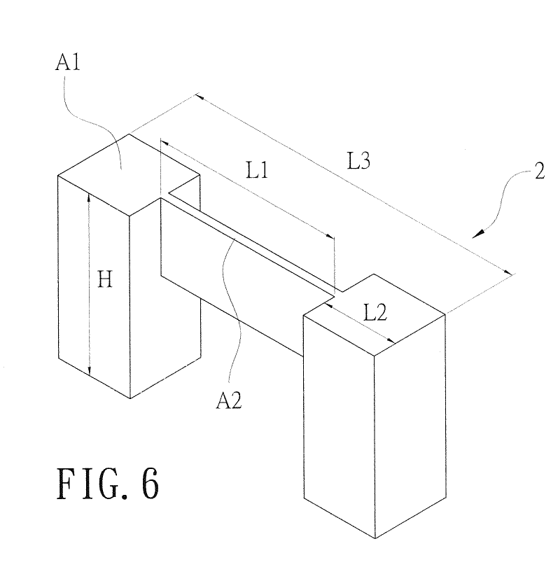

A three-dimensional graphene oxide microstructure 2 made by the foregoing method is also provided. Please refer to FIG. 5 and FIG. 6. FIG. 5 shows scanning images of a three-dimensional graphene oxide microstructure by a two-photon scanning microscope according to the embodiment of the present invention; and FIG. 6 shows a perspective view of a three-dimensional graphene oxide microstructure according to the embodiment of the present invention. In actually, FIG. 6 shows the perspective view of the three-dimensional graphene oxide microstructure 2 shown at the lower right corner of FIG. 5. In the three-dimensional graphene oxide microstructure 2 shown in FIG. 6, the cross sectional area (A₁) of the right and left square column is 7 μm² and the height (H) of the square column is 10 μm. The cross sectional area (A₂) of the cross beam connecting two square columns is 1.2 μm² and the length (L₁) of the cross beam is 10 μm. In addition, the length (L₃) of the three-dimensional graphene oxide microstructure is 25 μm. In the other words, the length (L₂) of two square columns plus the length (L₁) of the cross beam is 25 μm, so the length (L₂) of one square column is 7.5 μm. Other scanning images in FIG. 5 show 14 scanning images from the bottom to the top of the three-dimensional graphene oxide microstructure of FIG. 6.

However, the foregoing embodiments and drawings does not limits the product structures or uses of the present invention, it will be obvious to those skilled in the art that various modifications may be made without departing from the spirit and the scope of the present invention.

According to the above description and embodiments, the three-dimensional graphene oxide microstructure and the method for making the same in the present invention have the advantages as following:
1. In the three-dimensional graphene oxide microstructure and the method for making the same in the present invention, the two-proton cross-linking is proceed by multiphoton excitation of nonlinear optical technique of an ultrafast laser system to efficiently produce any free form of three-dimensional microstructure only containing graphene oxide, thereby expanding the application of the three-dimensional composites.
2. In the three-dimensional graphene oxide microstructure and the method for making the same in the present invention, the femtosecond laser instantly provides enough photon energy density in the focusing point to process the production of the any free form of three-dimensional microstructure of the graphere oxide, and the three-dimensional microstructure of the reduced graphene oxide (rGO) is efficiently produced via tuning the laser power and the scan rate of the femtosecond laser to achieve different levels of GO reduction and integrity of the structure.
3. Utilization of two-photon processing technique in the three-dimensional graphene oxide microstructure and the method for making the same in the present invention, any size of the three-dimensional microstructure of the graphene oxide can be efficiently designed and produced whereby producing any module structure to apply in any industry, and the three-dimensional microstructure of the graphene oxide can mix with any element to form a transistor containing p type and n type simultaneously and can efficiently integrate with biocompatible materials, proteins or organic framework to form a microfluidic biochip or precursor of disease, even to form optical material via three-dimensional mode for creating ultrashort pulse, whereby widely and efficiently applying to the development of photoelectric industry and biomedical industry.
4. The three-dimensional graphene oxide microstructure and the method for making the same in the present invention improve the difficulty in the development of transparent panel, ultrahigh speed transistor, graphene capacitor, and conductive ink. In the other words, the three-dimensional graphene oxide microstructure and the method for making the same in the present invention can efficiently improve the problem that hexagonal carbon structure of the traditional graphene can not be formed three-dimensional type and efficiently remedy the defects of the traditional graphene for making any free form of the three-dimensional graphene oxide microstructure.
5. The three-dimensional graphene oxide microstructure and the method for making the same in the present invention utilizes the unique characteristics of the graphene base like special bandgap, electric charge and ultrasmall resistance to make any photoelectric element such as optical amplifier, field-effect transistor, and wavelength shifter for expanding the development of three-dimensional composites and accelerating the development of high-speed transistor or super capacitor whereby reducing the size of the traditional electric elements and accelerating the development of superconductive industry.

What is claimed is:

1. A method for making a three-dimensional graphene oxide microstructure, comprising:
adding a photoreactive agent into a graphene oxide solution, wherein the photoreactive agent is a photoactivator in an nonlinear optical method;
activating the photoactivator in the graphene oxide solution by a beam emitting from an excitation module to produce a singlet oxygen with high activity; and
activating a graphene oxide by the singlet oxygen for an unpaired electron of the graphene oxide covalently bonding with another graphene oxide to form a three-dimensional graphene oxide microstructure.

2. The method according to the claim 1, wherein the photoreactive agent is a rose Bengal.

3. The method according to the claim 2, wherein the graphene oxide solution is prepared by immersing graphene oxide quantum dots into an aqueous solution, in order to provide a sufficient efficiency of two-photon cross-linking, the concentration of the graphene oxide quantum dots is 20 mg/ml, and the concentration of the rose Bengal is 5 mM.

4. The method according to the claim 3, wherein the graphene oxide quantum dots are prepared by aerating argon into graphene oxide nanosheets and removing a large size of graphene oxide quantum dots by centrifugation to obtain a graphene oxide quantum dots with the grain size from 2 nm to 5 nm.

5. The method according to the claim 4, in centrifugation step further comprising:
washing the graphene oxide quantum dots by ethanol; and
drying the graphene oxide quantum dots in an oven at 60° C. for 48 hours.

6. The method according to the claim 4, wherein the graphene oxide nanosheets are prepared by a preparation method, comprising the step of:
mixing a ground graphite powder with sodium nitrate and sulfuric acid in an ice bath container to form a first mixture;
mixing potassium permanganate into the first mixture by a stir to form a second mixture, wherein the temperature is kept below 20° C.;
elevating the temperature of the second mixture to 30° C.˜40° C. and keeping stirring until the graphite is oxidized;
diluting the second mixture with a deionized water after he graphite is oxidized;
adding a hydrogen peroxide into the second mixture and keeping stirring after dilution; and
drying the second mixture to obtain the graphene oxide nanosheets.

7. The method according to the claim 1, wherein the nonlinear optical method is a two-photon cross-linking method or a two-photon polymerization method, the photoreactive agent is a photoactivator in the two-photon cross-linking method and is a photoinitiator in the two-photon polymerization method.

8. The method according to the claim 1, wherein the excitation module is a femtosecond laser, the wavelength of the laser beam emitted from the femtosecond laser is from 700 nm to 800 nm, and the power of the laser beam is from 5 mW to 15 mW.
